(19) United States
(12) Patent Application Publication
(10) Pub. No.: US 2020/0377032 A1
(43) Pub. Date: Dec. 3, 2020

(54) CONFIGURABLE ROOF RACK FOR VEHICLES

(71) Applicant: Deyan Alex, Burlingame, CA (US)

(72) Inventor: Deyan Alex, Burlingame, CA (US)

(21) Appl. No.: 16/885,768

(22) Filed: May 28, 2020

Related U.S. Application Data
(60) Provisional application No. 62/854,731, filed on May 30, 2019.
(60) Provisional application No. 62/854,237, filed on May 29, 2019.
(60) Provisional application No. 62/854,231, filed on May 29, 2019.
(60) Provisional application No. 62/854,229, filed on May 29, 2019.
(60) Provisional application No. 62/854,225, filed on May 29, 2019.
(60) Provisional application No. 62/854,222, filed on May 29, 2019.
(60) Provisional application No. 62/854,210, filed on May 29, 2019.

(51) Int. Cl. B60R 9/058

(52) U.S. Cl. CPC B60R 9/058

(57) ABSTRACT

A configurable roof rack for vehicles is provided. The configurable roof rack comprises at least two cross bars arranged parallelly, wherein each of the at least two cross bars comprises a channel. The configurable roof rack further comprises a rack comprising an inner cross bar at each of two opposite sides of the rack, wherein the rack is configured to be fitted into the at least two cross bars by sliding the inner cross bars into the channels of the at least two cross bars, wherein each of the two cross bars comprises a key slot for enabling locking and unlocking of the rack to the at least two cross bars.

### CROSS REFERENCE TO RELATED APPLICATIONS

This application claims the benefit of U.S. Provisional Patent Application No. 62/854,210 filed May 29, 2019, U.S. Provisional Patent Application No. 62/854,222 filed May 29, 2019, U.S. Provisional Patent Application No. 62/854,225 filed May 29, 2019, U.S. Provisional Patent Application No. 62/854,229 filed May 29, 2019, U.S. Provisional Patent Application No. 62/854,231 filed May 29, 2019, U.S. Provisional Patent Application No. 62/854,237 filed May 29, 2019, and U.S. Provisional Patent Application No. 62/854,731 filed May 30, 2019, all of which are incorporated by reference in their entirety.

### FIELD OF THE INVENTION

This invention relates to a configurable roof rack, and in particular, a rack which is configured to be inserted and removable into two cross bars through a hand grip, and further configured to be locked/unlocked with a mechanical key.

### BACKGROUND OF THE INVENTION

Regular vehicle racks on the top of vehicles are generally rigid and fixed. It is generally desirable that the vehicle racks be folded or hidden when not in use, since the racks look ugly with a huge structure over the top of vehicles. However, the racks are conventionally not easily removable or foldable from the vehicle's top without help from an expert technician, for example, at a car service station.

Currently, the vehicle racks are also being deployed for advertising purposes with in-built display systems. With the integrated built-in display systems, the vehicle racks have been becoming more complex, and more cumbersome to be folded or hidden by the vehicle owners or drivers. Due to the complex structure of conventional racks, it generally requires involvement of expert technicians to fold, hide, or remove them. Additionally, once the display system-based vehicle racks are installed, the racks are rendered unusable for carrying any luggage. Further, the conventional roof rack crossbars for vehicles are unusable for multiple different racks, and are rather limited to be ideal only for the rack fixed on the vehicle roof.

Presently, there are no solutions to have an integrated display system-based vehicle rack that may also be used like conventional vehicle racks to carry luggage. Also, there are no solutions to hide, fold, or change any configuration of the vehicle racks when not needed.

Additionally, conventional display systems on vehicle roofs include methods for playing electronic content either through direct streaming through a wireless carrier or in-built ad players with hard disk and memory. However, such conventional systems make the electronic content static, without any intelligent mechanism to provide dynamic content to be played therein.

### SUMMARY OF THE INVENTION

The present invention seeks to provide a solution to all the above stated problems by providing a configurable roof rack for vehicles with a convenient mechanism to be folded or hidden or removed from public displays by the driver when desired. Specifically, the present invention provides for a mechanical as well as electronic systems for folding/unfolding/removing of the configurable roof rack for vehicles. Further, the present invention provides for providing a mechanism for controlling the electronic content to be displayed on a display system integrated with the configurable roof rack.

The present invention seeks to provide a removable vehicle rack that can be easily removed from the vehicle and stored when not needed. The user can reinstall the rack easily when needed. Further, the present invention seeks to provide a roof rack crossbar that has features that lets the user attach many different kinds of specially designed removable racks onto these crossbars.

The present invention seeks to provide an electronic display attached to a foldable vehicle rack that can be folded and hidden by the driver when not needed. Once folded, the driver can wash the car in any automatic car washes. Drivers can feel not ashamed when the roof rack is hidden at times when they do not need the racks. Versions of the installation could include one or more displays simultaneously on the roof, back, front or any sides of the vehicle or any combinations of therewith.

The content or material to be displayed on this electronic display can be sourced or streamed directly from a wireless carrier using 3G, 4G or 5G or any future similar technologies. Preferably, the content can be streamed through an app on the user's smart phone. Preferably, the electronic display unit can be removed easily and reinstalled easily without any help or expert tools.

The present invention seeks to provide a mobile app driver technology to stream advertisements to electronic displays on vehicles. These electronic displays can be located outside or inside the vehicles. The mobile app streams digital content to the displays using wireless technologies like Wi-Fi, Bluetooth or similar.

According to one embodiment of the present invention, a configurable roof rack for vehicles is provided. The configurable roof rack comprises at least two cross bars arranged parallelly, wherein each of the at least two cross bars comprises a channel. The configurable roof rack further comprises a rack comprising an inner cross bar at each of two opposite sides of the rack, wherein the rack is configured to be fitted into the at least two cross bars by sliding the inner cross bars into the channels of the at least two cross bars, wherein each of the two cross bars comprises a key slot for enabling locking and unlocking of the rack to the at least two cross bars.

### BRIEF DESCRIPTION OF THE DRAWINGS

Some embodiments of the present invention are illustrated as an example and are not limited by the figures or measurements of the accompanying drawings, in which like references may indicate similar elements and in which:

FIG. 1 depicts a vehicle with a roof for installation of a configurable roof rack, in accordance with the various embodiments of the present invention.

FIGS. 2A-2G depict a configurable roof rack comprising a display rack in various positions during installation, in accordance with some embodiments of the present invention.

FIG. 3 depicts an isometric view of the cross bars of the configurable roof rack along with their respective grooves, in accordance with various embodiments of the present invention.

FIGS. 4A-4E depict various views of either of the cross bars of the configurable roof rack, in accordance with various embodiments of the present invention.

FIGS. 5A and 5B depict front/back view of the configurable roof rack upon installation at the roof of the vehicle, when display rack is in the folded and unfolded positions respectively, in accordance with some embodiments of the present invention.

FIGS. 6A and 6B depict side view of the configurable roof rack upon installation at the roof of the vehicle, when display rack is in the folded and unfolded positions respectively, in accordance with some embodiments of the present invention.

FIGS. 7A and 7B depict top view of the configurable roof rack upon installation at the roof of the vehicle, when display rack is in the folded and unfolded positions respectively, in accordance with some embodiments of the present invention.

FIGS. 8A and 8B depict bottom view of the configurable roof rack upon installation at the roof of the vehicle, when display rack is in the folded and unfolded positions respectively, in accordance with some embodiments of the present invention.

FIG. 9 depicts an isometric view of the configurable roof rack when the display rack is in the unfolded position, in accordance with some embodiments of the present invention.

FIGS. 10A and 10B depict front/back view of an exemplary automated configurable roof rack when the display rack is in the folded and unfolded positions respectively, in accordance with some embodiments of the present invention

FIGS. 11A and 11B depict side view of an exemplary automated configurable roof rack upon installation at the roof of the vehicle, when display rack is in the folded and unfolded positions respectively, in accordance with some embodiments of the present invention.

FIGS. 12A and 12B depict top view of an exemplary automated configurable roof rack upon installation at the roof of the vehicle, when display rack is in the folded and unfolded positions respectively, in accordance with some embodiments of the present invention.

FIGS. 13A and 13B depict bottom view of an exemplary automated configurable roof rack upon installation at the roof of the vehicle, when display rack is in the folded and unfolded positions respectively, in accordance with some embodiments of the present invention.

FIGS. 14A-14D depict isometric views of an exemplary automated configurable roof rack, when the display rack is in the folded and unfolded positions, in accordance with some embodiments of the present invention.

FIG. 14E depicts an isometric view of an exemplary shaft and flat connector/hinge, in accordance with some embodiments of the present invention.

FIG. 14F depicts a more detailed view of other components of the controller box or enclosure in communication with a display system, a mobile device, and a base station, in accordance with various embodiments of the present invention

FIGS. 15A and 15B depict the unfolded views of the display rack comprising one or more display systems, according to some embodiments of the present invention.

FIG. 16 depicts an isometric top view of the display rack in folded position, according to some embodiments of the present invention.

FIGS. 17A and 17B depict top view of another exemplary automated configurable roof rack upon installation at the roof of the vehicle, when display rack is in the unfolded and folded positions respectively, in accordance with some embodiments of the present invention.

FIG. 18 illustrates a method of operating the configurable roof rack for vehicles, in accordance with various embodiments of the present invention.

FIG. 19 illustrates a method performed by the mobile device for operating the configurable roof rack for vehicles, in accordance with various embodiments of the present invention.

FIG. 20 illustrates a user interface of the mobile device, in accordance with various embodiments of the present invention.

FIG. 21 illustrates a system for providing electronic content for displaying on the one or more display systems of the display rack, in accordance with various embodiments of the present invention.

FIG. 22 depicts a user providing an input through a mobile device, to start or stop content streaming to one or more display systems on top of the vehicle, in accordance with various embodiments of the present invention.

FIG. 23 illustrates an example computer program product that is configured to enable display of electronic content on one or more display systems and/or fold/unfold the display rack, in accordance with various embodiments of the present invention.

FIG. 24 is a block diagram illustrating an example computing device that is configured to enable display of electronic content on one or more display systems and/or fold/unfold the display rack, in accordance with various embodiments of the present invention.

### DETAILED DESCRIPTION OF DRAWINGS

The present invention will now be described by referencing the appended figures representing preferred embodiments.

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

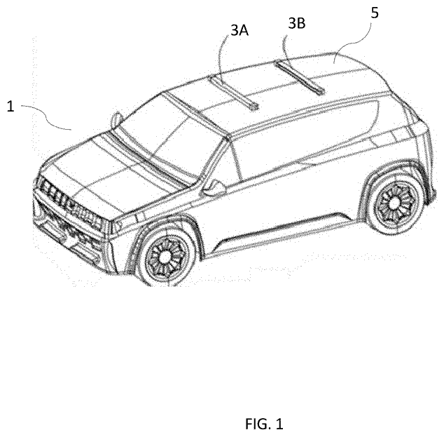

FIG. 1 depicts a vehicle 1 having a roof 5, in accordance with the various embodiments of the present invention. In accordance with the various embodiments of the present invention, the configurable roof rack (not shown in FIG. 1) is installed over the roof 5.

While the Figure depicts the vehicle 1 as a car, it may be apparent to a person skilled in the art that the vehicle 1 may include any vehicle capable of possessing a roof generally at its top. For example, the vehicle 1 may include, but not limited to, a car, truck, a roof possessing two-wheeler automobile, a three-wheeler automobile, etc. The roof 5 may be an area of a structure which covers an automobile/vehicle at the top. For example, the roof 5 may be area of the structure between the front and back windshield at the top of a car, or an area of a cover a truck covering the portion carrying passengers and luggage/load. Also, as well known in the art, the area of roof 5 may be used to install a rack or a luggage carrier.

The vehicle 1 may comprise at least two cross bars 3A and 3B that may be fixed to the roof 5 of the vehicle 1 through cross bar clamps (not shown in FIG. 1). As is generally known in the art, the cross bar clamps are affixed to the roof 5 of the vehicle for installation of a rack or a luggage carrier. In a preferred embodiment of the present invention, each of the two cross bars 3A and 3B may be affixed to the roof 5 through two cross bar clamps each. The coupling of cross bar clamps with the two cross bars 3A and 3B may be performed through any well-known mechanism in the art. In accordance with various embodiments of the present invention, the cross bars 3A and 3B may be designed as per the various designs discussed hereinafter, and the configurable roof rack may be installed between the cross bars 3A and 3B.

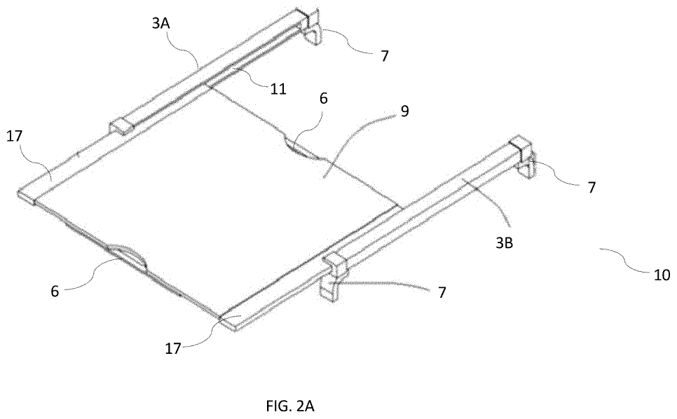

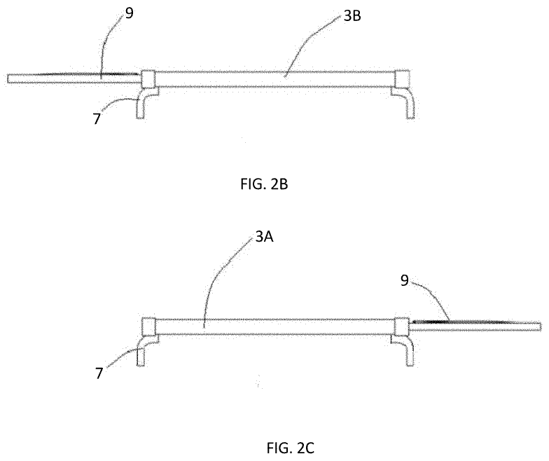

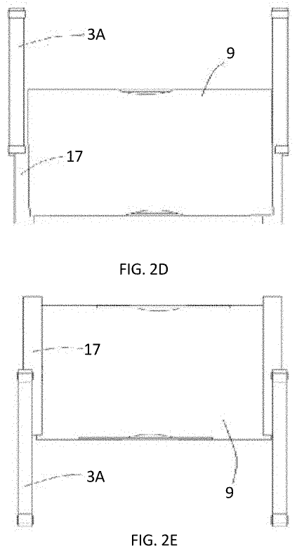

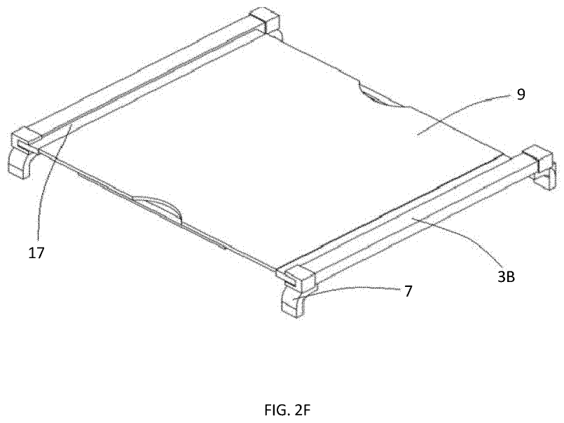

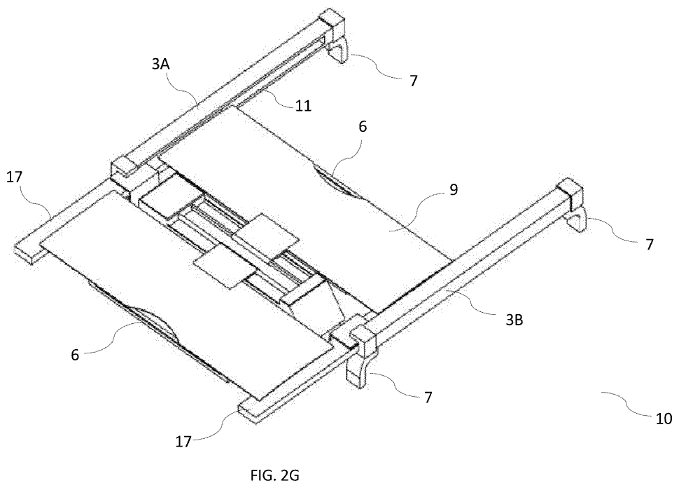

FIG. 2A depicts a configurable roof rack 10 according to one embodiment of the present invention. As depicted, the configurable roof rack 10 comprises two crossbars 3A and 3B, a display rack 9, and two cross car clamps 7 each for the cross bars 3A and 3B. FIG. 2A further depicts how the cross bars 3A and 3B, and the display rack 9 may be used together to make the configurable roof rack 10 system a modular structure.

The display rack 9 comprises inner cross bars 17 at two of its sides, as depicted. The display rack 9 is pushed into and pulled out of the cross bars 3A and 3B using grips 6 provided at two opposite ends on the other two sides of the display rack 9, the other two sides being perpendicular to the two sides including the inner cross bars 17. The grips 6 provide a hand grip to push the display rack 9 in and out of the cross bars 3A and 3B. The cross bars 3A and 3B may be fixed to the roof of the vehicle using cross bar clamps 7. The pushing in and out of the display rack 9 is performed through the inner cross bars 17 that get inserted into the cross bars 3A and 3B. The cross bars 3A and 3B are generally permanently fixed upon installation on the roof 5 of the vehicle through cross bar clamps 7, and the inner cross bars are movable. Accordingly, the cross bars 3A and 3B may also be referred to as fixed cross bars 3A and 3B.

Each of the cross bars 3A and 3B comprises a groove 11 which runs in the middle through the length of the corresponding cross bar. While a groove 11 is depicted as an example, it may be appreciated that similar mechanisms such as a guide or channel may be used. The grove 11 is used to push the display rack 9 into or out of the cross bars 3A and 3B, by sliding the inner cross bars 17 in and out of the cross bars 3A and 3B. As depicted in FIG. 1 and FIG. 2, the cross bars 3A and 3B are installed on the roof 5 in a manner, such that their respective grooves 11 face each other, thereby facilitating pushing in and out of the display rack 9 from the cross bars 3A and 3B.

The display rack 9 may be for example, but not limited to, a carbon fiber sheet. The thickness and strength of the display rack 9 may be suitably chosen in order to mount an electronic display thereupon, as described later here in the specification. In an exemplary embodiment, the display rack 9 may be made up of one-inch thick carbon fiber sheet. While some embodiments described here illustrate display rack 9 as a rack for mounting displays thereupon, it would be appreciated that the display rack 9 may be instead used as a rack for carrying luggage without any display systems mounted thereupon. Additionally, even in embodiments where the display rack 9 includes mounted display systems, the display rack may be used for carrying luggage when the display rack is in a folded position (described later).

FIG. 2B depicts the display rack 9 partially pulled out from the cross bars 3A and 3B when viewed from back of the vehicle 1. The display rack is pushed in and out of the cross bars 3A and 3B preferably from the sides of the vehicle 1, and not from the front or back side of the vehicle 1 as the cross bars 3A and 3B are installed parallel to the front/back of the vehicle 1.

FIG. 2C depicts the same position of the display rack when seen from the front of the vehicle 1. Similarly, FIG. 2D depicts the same position of the display rack when seen from the top. As depicted, the display rack 9 is fixed to the inner cross bars 17 that get inserted into the cross bars 3A and 3B. The (fixed) cross bars 3A and 3B, and the moving inner cross bar 17 assist in removing or re-installing the display rack 9.

Similarly, FIG. 2E depicts the same position of the display rack when seen from the bottom. FIG. 2F depicts an isometric view of the fully inserted display rack 9 into the cross bars 3A and 3B.

While FIGS. 2A-2F depict the display rack 9 as one part/portion according to some embodiments of the present invention, it may be made up of two parts/portions according to other embodiments of the present invention, as also explained later in the specification. FIG. 2G depicts a configurable roof rack 10, where the display rack 9 is depicted in 2 parts or portions, according to various embodiments of the present invention. It would be apparent to a person skilled in the art that the display rack 9 would appear in a similar manner in FIGS. 2A-2F upon replacement with the exemplary display rack of FIG. 2G.

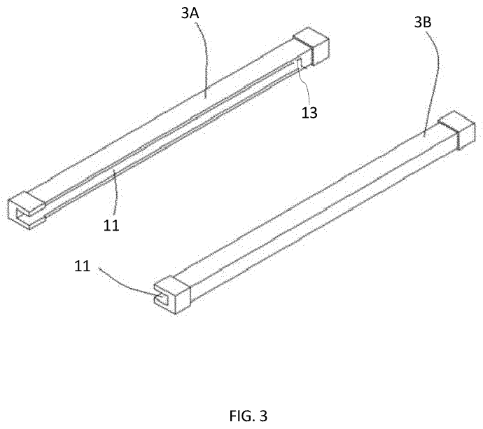

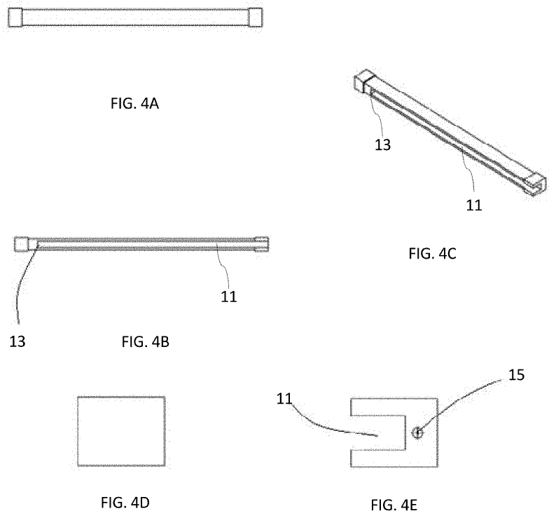

FIG. 3 depicts an isometric view of the cross bars 3A and 3B along with their respective grooves 11, in accordance with various embodiments of the present invention. As depicted, each of the cross bars 3A and 3B comprises a hollow opening at one end, while a stopper 13 at the other end. Upon installation of the cross bars 3A and 3B over the roof 5 of the vehicle 1, a removable display rack 9 may be inserted into the grooves 11. For example, the left side of the display rack 9 may be inserted through the groove 11 of the cross bar 3A, and the right side of the display rack 9 may be inserted through the groove 11 of the cross bar 3B. Further, once the display rack 9 is pushed completely into the groove 11, the display rack may be locked into the cross bar clamps 3A and 3B when the display rack 9 hits the stopper 13. In addition to the stopper 13 at one end of each of the cross bars 3A and 3B, the locking of the display rack 9 may be further ensured by a locking mechanism 15 (shown in FIG. 4), as detailed hereinafter.

FIGS. 4A-4E depict various views of either of the cross bars 3A/3B, in accordance with various embodiments of the present invention. Specifically, while FIG. 4A depicts a view of a cross bar 3A/3B from one side, FIGS. 4B and 4C depict the views from the other side where the groove 11 and stopper 13 are clearly visible. FIG. 4D depicts a back view of the cross bar 3A/3B, and FIG. 4E depicts the front view. FIG. 4E depicts the grove 11, which runs through the length of the cross bar 3A/3B. In accordance with various embodiments of the present invention, a manual key slot 15 may be available to completely lock the display rack 9 once it is inserted completely into the groove 11 of the cross bar 3A/3B. A key may be inserted which fits into the size of the manual key slot 15, and subsequently, the key may be rotated in a predefined direction (i.e., clockwise or anti-clockwise) to lock the display rack 9. Further, a mechanical latch (not shown) may be coupled to the manual key slot for locking the display rack 9 into the cross bars 3A/3B. As would be appreciated by a person skilled in the art, the mechanical latch may be a latch well-known in the art, and is not described here in detail. For opening/removing the display rack 9 from the configurable roof rack 10, a user may simply use a key for fitting into the manual key slot 15 and pull out the display rack 9 out. Such a configuration facilitates easy installing and uninstalling of the display rack 9 from the configurable roof rack 10 without taking any assistance from expert technician in the domain.

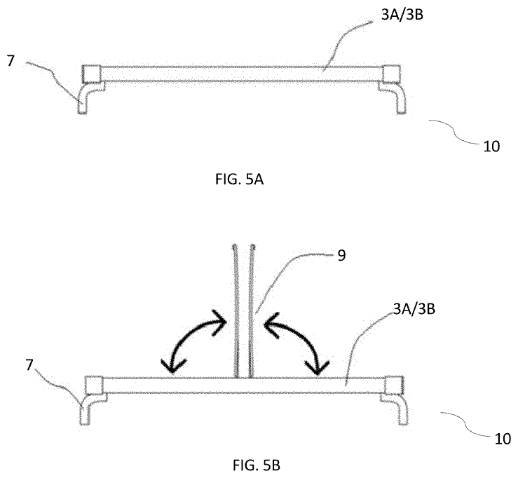

FIG. 5A depicts front and/or back view of the configurable roof rack 10 upon installation at the roof 5 of the vehicle 1, in accordance with some embodiments of the present invention. In particular, FIG. 5A depicts a view of the front and/or back of the vehicle 1, when display rack 9 is in a folded position. The folded position of the display rack 9 may be defined as the position when display rack 9 lies substantially parallel to the roof 5 of the vehicle 1. Additionally, and/or alternatively, the folded position of the display rack 9 may be defined as a position when the display rack 9 lies parallel to the cross bars 3A and 3B. Further, additionally and/or alternatively, the folded position of the display rack 9 may be defined as a position when the display rack 9 is not configured to display any electronic content, as defined later in the various embodiments of the present invention. Furthermore, the folded position of the display rack 9 may be defined as the position when display rack 9 may be used for carrying luggage.

As discussed previously, the display rack 9 is installed to cross bars 3A and 3B through cross bar clamps 7 of the vehicle 1. When in a folded position, the display rack 9 is hidden from the back and front view, of the vehicle 1, behind the cross bars 3A/3B.

FIG. 5B depicts front and back view of the configurable roof rack 10 upon installation at the roof 5 of the vehicle 1, in accordance with some embodiments of the present invention. In particular, FIG. 5B depicts a view of the front and back of the vehicle 1, when display rack 9 is in the unfolded or open position. The unfolded or open position of the display rack 9 may be defined as the position when display rack 9 lies substantially at 90° or perpendicular to the roof of the vehicle. Additionally, and/or alternatively, the unfolded position of the display rack 9 may be defined as a position when the display rack 9 lies at 90° or perpendicular to the cross bars 3A and 3B. Further, additionally and/or alternatively, the unfolded position of the display rack 9 may be defined as a position when the display rack 9 is configured to display electronic content, as defined later in the various embodiments of the present invention.

When in the unfolded position, the display rack 9 is visible from the back and front view, of the vehicle 1, as depicted in FIG. 5B. As depicted, the display rack 9 comprises two portions or parts, each configured to be in an unfolded position from the center of the cross bars 3A and 3B, as also explained later herein. Additionally, the motion of the two portions/parts from the folded to unfolded position is depicted by the two arrows in FIG. 5B. The portions/parts are configured to depict a motion similar to butterfly wings when changed from folded to unfolded position and vice-versa. In other embodiments of the present invention, the portions/parts of the display rack 9 may be configured to be folded and unfolded from anywhere on the roof or front or back or sides of the vehicle.

Each of the two portions/parts of the display rack 9 may include an electronic display device coupled thereto, as explained later throughout this specification. The configuration of the display rack 9 in two small portions/parts facilitates easier management of the displays. Further, the two smaller displays compared to one bigger single display facilitates easy removal and transport of the displays when desired. Furthermore, the two displays mounted on the display rack 9 are installed facing away from each other, such that they facilitate a better view both towards pedestrians on one side of the vehicle 1, as well as traffic in adjacent lanes on the other side of the vehicle 1, thereby facilitating better coverage and more viewership. Additionally, the two portions/parts in the folded position provide a better support for carrying luggage at the top of the vehicle 1, when the display rack 9 is in the folded position.

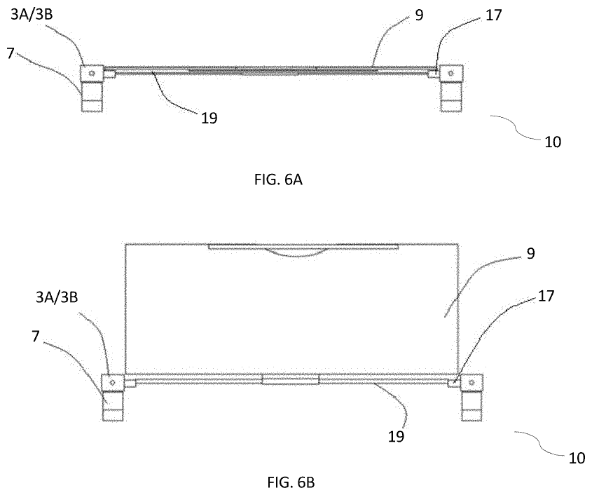

FIG. 6A depicts the folded view of the configurable roof rack 10 from either side of the vehicle 1. In accordance with some embodiments of the present invention, the display rack 9 rests on an inner cross bar 17 that goes into the cross bar 3A/3B. FIG. 6B depicts side view of the configurable roof rack 10 from either side of the vehicle 1, when the display rack 9 is in the unfolded or open position. Each of the two displays of the display rack 9 is connected to the inner crossbars 17 by a shaft 19 that helps to pivot the foldable rack and assist in folding and unfolding as shown by the arrows.

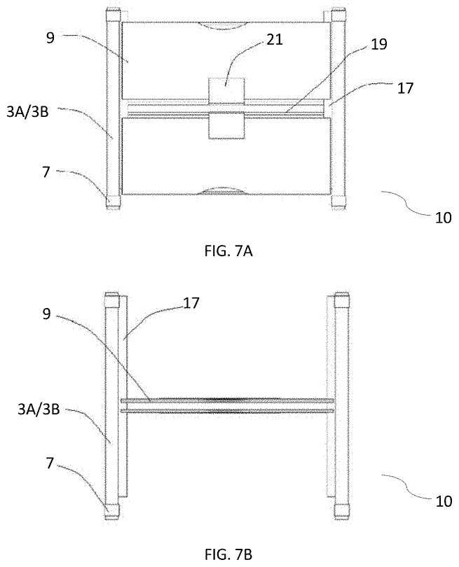

FIGS. 7A and 7B depict the folded and unfolded view of the configurable roof rack 10 from the top respectively. Each shaft 19 is attached to the corresponding display rack 9 by a flat connector or hinge 21. The shafts 19 are connected between the inner crossbars 17, and the display rack 9 rests on these inner crossbars 17 when folded.

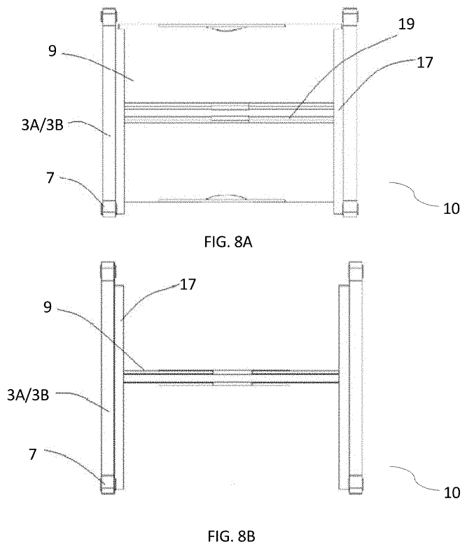

FIGS. 8A and 8B depict the folded and unfolded view of the configurable roof rack 10 from bottom respectively. This view is the same from top except that there is no flat connector or hinge 21 at the bottom of the display rack 9.

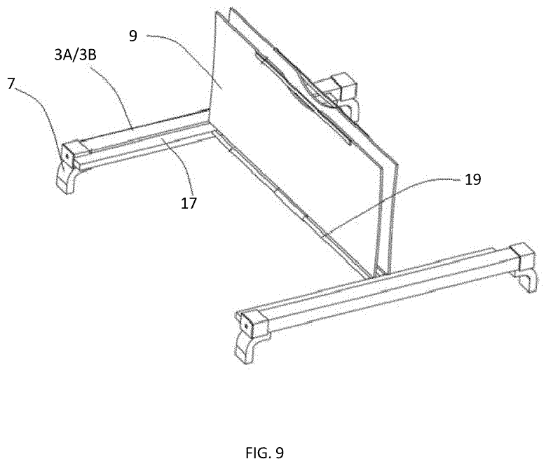

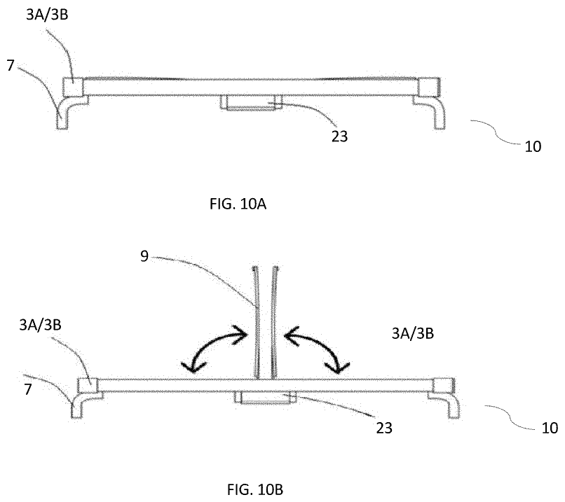

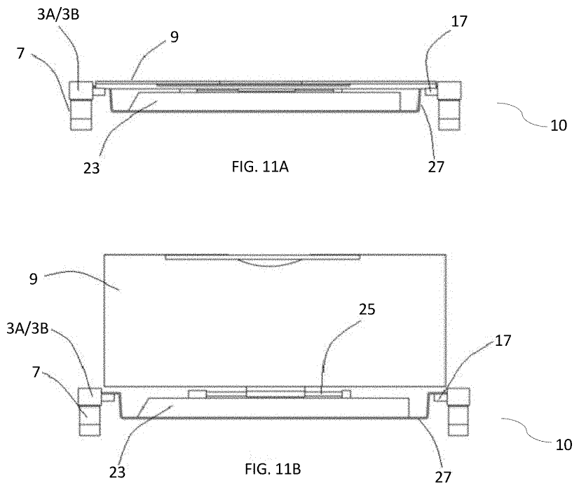

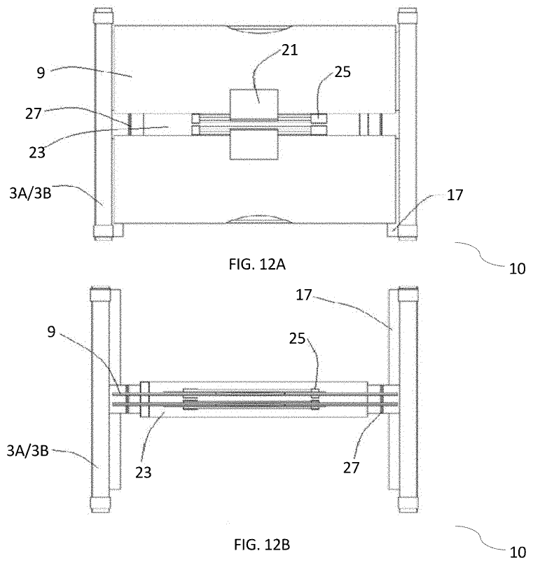

FIG. 9 depicts an isometric view of the configurable roof rack 10 when the display rack 9 is in an unfolded position.

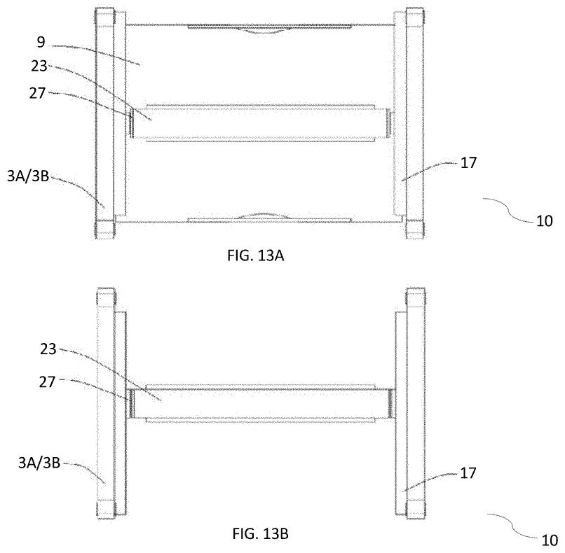

FIGS. 10A and 10B illustrate another exemplary configurable roof rack 10 in accordance with various embodiments of the present invention. The configurable roof rack 10 of FIGS. 10A and 10B is configured to be operated in an automated manner by a user through a user mobile device. The user may include, but not limited to, a driver of the vehicle 1, a passenger currently traveling in the vehicle 1, a remote operator who operates the configurable roof rack 10 through any wireless communication technologies like Wi-Fi, Bluetooth, etc.

According to a preferred embodiment of the present invention, the operation of the configurable roof rack 10 in an automated manner implies that the display rack 9 of the configurable roof rack 10 may be folded or unfolded through an automated software application provided to the user. A controller box or enclosure 23 houses all the electronic, electrical, mechatronic and automation components including wires, circuit boards, Wi-Fi adapters and sensors. A motor and gear system may also be housed which is connected to the display rack 9 through a gear shaft 25 and a flat connector or hinge plate 21 (not shown in FIG. 10A/10B). This allows the display rack 9 to follow a butterfly wings motion to fold and unfold. Preferably, the motor and gear can be operated remotely from a remote control or a software based mobile application using sensors, Wi-Fi and Bluetooth transmitters and receiver circuits housed in the controller box 23.

FIG. 10A depicts front and back view of the automated configurable roof rack 10 upon installation at the roof 5 of the vehicle 1, in accordance with some embodiments of the present invention. In particular, FIG. 10A depicts a front and back view of the automated configurable roof rack 10, when display rack 9 is folded.

As discussed previously, the display rack 9 is installed to cross bars 3A and 3B through cross bar clamps 7 of the vehicle 1. When in a folded position, the display rack 9 is hidden from the back and front view, of the vehicle 1, behind the cross bars.

FIG. 10B depicts front and back view of the automated configurable roof rack 10 upon installation at the roof 5 of the vehicle 1, in accordance with some embodiments of the present invention. In particular, FIG. 10B depicts a view of the front and back of the vehicle 1, when display rack 9 is unfolded or open.

When in the unfolded position, the display rack 9 is visible from the back and front view, of the vehicle 1, as depicted in FIG. 10B. As depicted, the display rack 9 comprises two portions, each configured to be in an unfolded position from the center of the cross bars 3A and 3B, as also explained later herein. Additionally, the movement of the two portions from the folded to unfolded position is depicted by the two arrows in FIG. 10B. The portions are configured to depict a motion similar to butterfly wings when changed from folded to unfolded position and vice-versa. In other embodiments of the present invention, one or more portions of the display rack 9 may be configured to be folded and unfolded from anywhere on the roof or front or back or sides of the vehicle.

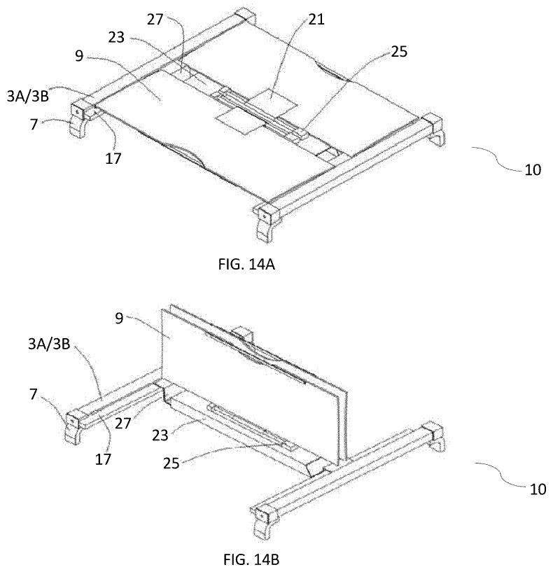

FIG. 11A depicts the folded view of the automated configurable roof rack 10 from either side of the vehicle 1. In accordance with some embodiments of the present invention, the display rack 9 rests on an inner cross bar 17 that goes into the cross bar 3A/3B. The controller box 23 resides on a platform 27 that is connected between the inner cross bars 17. In an exemplary embodiment of the present invention, the platform 27 may be, but not limited to, a metal or a carbon fiber plate attached to the inner cross bars 17. Preferably, the platform 27 may be permanently attached, such as by welding, with its each end welded to one of the inner cross bars 17 substantially around the middle of these inner cross bars 17 bars for supporting the display rack 9, shafts 25 as well as the controller box 23. The platform 27 may have suitable dimensions such that it fully covers the width of the controller box 23 and the shafts 25. In one exemplary embodiment, the platform 27 may be at least one foot wide. FIG. 11B depicts side view of the automated configurable roof rack 10 from either side of the vehicle 1, when the display rack 9 is in the unfolded or open position. Each of the two displays of the display rack 9 is connected to the gear shaft 25 using a flat connector or hinge 21 (not shown in FIG. 11A/11B) on the upper side. This gear shaft 25 helps to pivot the automated configurable roof rack 10 and helps it fold and unfold as shown by the arrows in FIG. 10B.

FIG. 12A depicts the folded view of the automated configurable roof rack 10 from the top. Each gear shaft 25 is attached to the corresponding portion of the display rack 9 by a flat connector or hinge 21. The gear shafts 25 are connected to the controller box 23. FIG. 12B depicts the automated configurable roof rack 10 in the unfolded position. The controller box 23 resides on a platform 27 that is connected between the inner crossbars 17.

FIGS. 13A and 13B show the folded and unfolded views of the automated configurable roof rack 10 from bottom respectively. These views are the same from the top (FIGS. 12A and 12B) except the gear shafts 25 are not visible. However, the platform 27 that the controller box 23 is attached to, is visible in the bottom view.

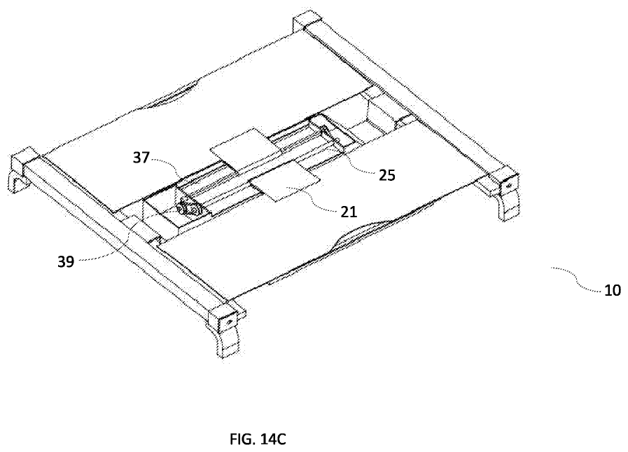

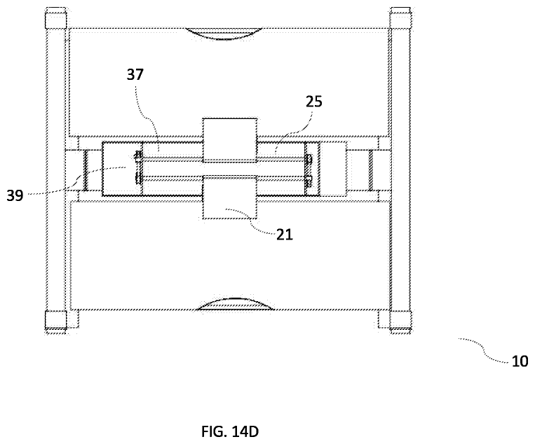

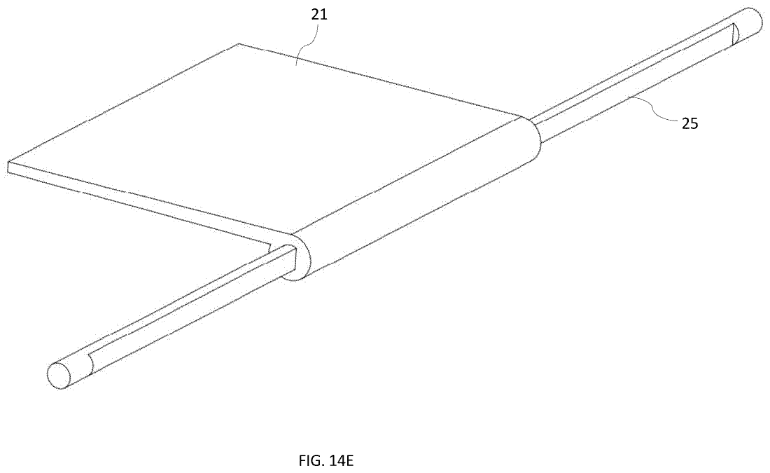

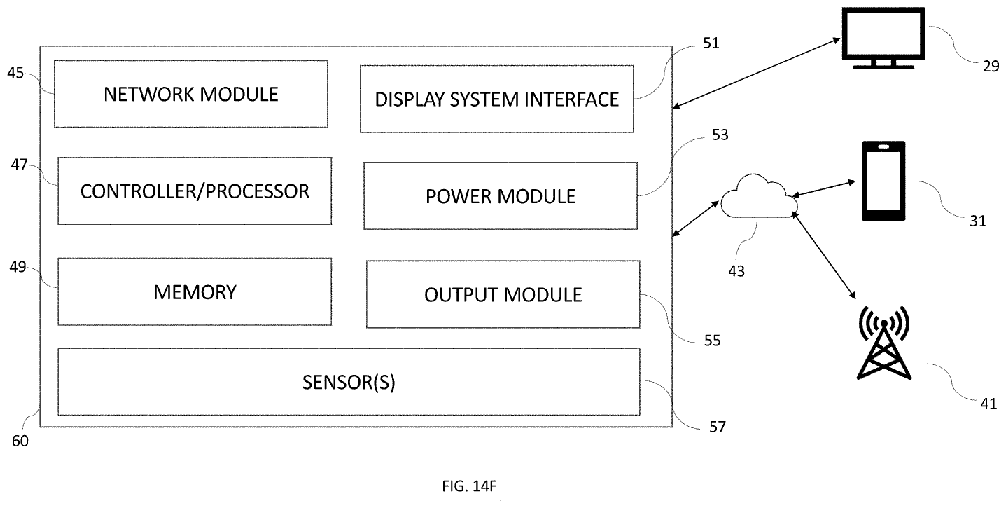

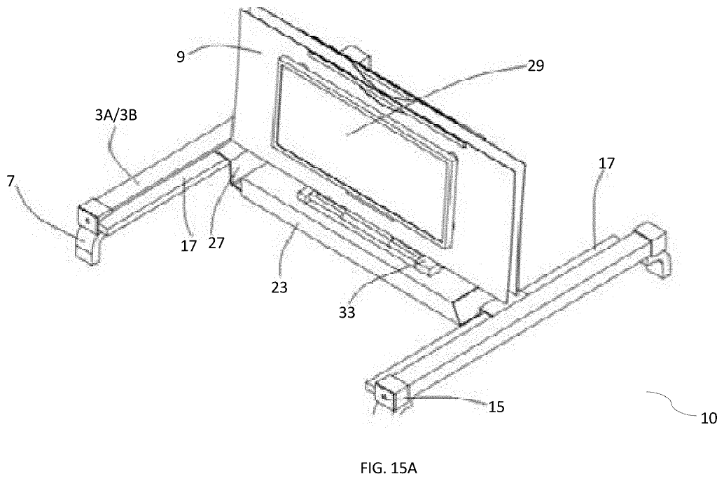

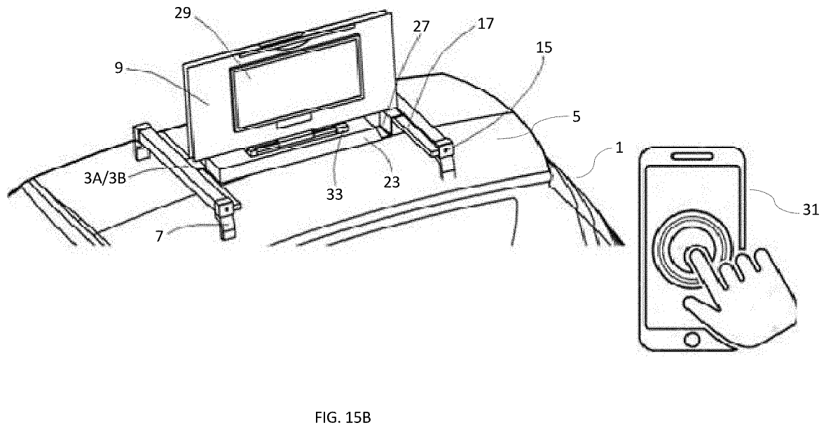

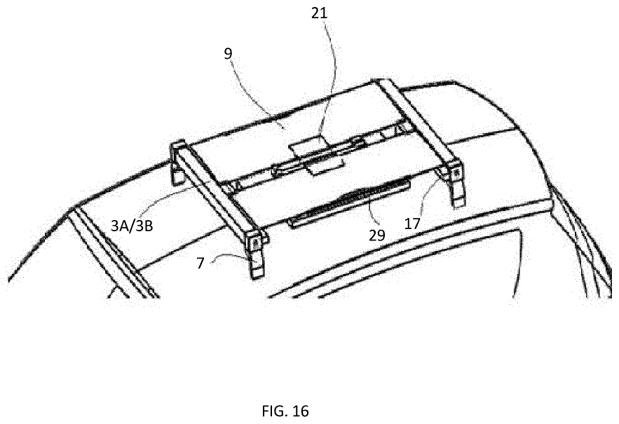

FIG. 14A depicts an isometric view of the automated configurable roof rack 10, when the display rack 9 is in the folded position. FIG. 14B shows a similar view except that the display rack 9 is in the unfolded or open position.

In operation, the user presses a button/key (or a touch input) through a user interface of a software mobile application on the user electronic device, such as a mobile phone, tablet, etc. that sends wireless signals that is received by a wireless receiver housed in the controller box 23, that in turn, operates the motor and shaft, which in turn rotates the shafts clockwise or counter clockwise to fold and unfold the foldable racks.

FIGS. 14C and 14D depict a detailed view of the controller box or enclosure 23, according to various embodiments of the present invention. As depicted, the controller box 23 comprises a shaft 25 each for the two portions/parts of the display rack 9. Each shaft 25 is coupled to a corresponding motor 37 and a belt and pulley drive 39. The motor 37 may be provided with a gear drive to rotate the associated portion/part of the display rack 9. In a preferred embodiment of the present invention, motor 37 may be a break motor with a torque of around 90 Nm, so that the configurable roof rack 10 does not need any additional locking system to hold the display rack 9 during the unfolded position. Further, each shaft 25 is coupled to the associated portion/part of the display rack 9 through the flat connected or hinge 21.

In operation, the shaft 25 is rotated through the combined mechanism of the motor 37 and the belt and pulley drive 39, upon receiving a control signal from an output module (described later) in the controller box or enclosure 23. In order to unfold the portions/parts of the display rack 9, the shafts 25 may be pre-configured to be rotated by the motor 37 and the belt and pulley drive 39, such that the portions/parts of the display rack 9 move from being substantially parallel to the roof 5 of vehicle 1 to being substantially perpendicular to the roof 5 of the vehicle 1. Similarly, the shafts 25 may be pre-configured to be rotated by the motor 37 and the belt and pulley drive 39, such that the portions/parts of the display rack 9 move from being substantially perpendicular to the roof 5 of vehicle 1 to being substantially parallel to the roof 5 of the vehicle 1.

FIG. 14E depicts an isometric view of an exemplary shaft 25 and flat connector/hinge 21, in accordance with some embodiments of the present invention. As depicted, the each shaft 25 has a dented structure at one of its side, which assists in fitment of the flat connector/hinge 21 firmly into the shaft. Preferably, the flat connector/hinge 21 is fitted around the center of each shaft 25, in order to support the rotation of display rack 9.

FIG. 14F depicts a more detailed view of other components of the controller box or enclosure 23 in communication with a display system, a mobile device, and a base station, in accordance with various embodiments of the present invention. The components of the controller box 23 depicted in FIG. 14F are collectively referred to as a control unit 60 here. According to one embodiment of the present invention, the control unit 60 comprises a network module 45, a controller/processor 47, a memory 49, a display system interface 51, a power module 53, and an output module 55. It should be noted that not all of these components must be employed in order to practice the present invention.

The network module 45 facilitates data exchange between the control unit 60 and a base station 41/a mobile device 31. In one embodiment, the network module 45 operates to facilitate the control unit 60 to exchange data with the base station 41 or the mobile device 31 over a wireless network 43. The network module 45 may be configured to receive an input from the mobile device 31 to fold or unfold the display rack 9, in accordance with various embodiments of the present invention. Additionally, the network module 45 may be configured to receive one or more inputs from the mobile device 31 or the base station 41 to control the display of the electronic/media content on the display systems 29, in accordance with various embodiments of the present invention. In one example, the network module 45 operates in accordance with a commonly used protocol such as UDP, TCP/IP or a cellular protocol. Further, the network module 45 may include a modem (not shown) and a transmit/receive antenna (not shown). In some embodiments of the present invention, the network module 45 may be configured to support multiple connections with different wireless communication devices using different radio access technologies.

The controller/processor 47 controls operations of these and other components of the control unit 60 and causes the display system interface 51 to communicate with the display system 29 in order to display the desired electronic content in a desired manner.

Upon receiving the inputs from the display system interface 51 of the control unit 60, a media processor (not shown) of the display system 29 is configured to perform processing of electronic/media content to be displayed on the display system 29. One of the features in the present invention is that the display system 29 displays all types of electronic/media content including, but not limited to, static or moving graphics, texts, animations as well as motion images. The media processor may be configured to retrieve electronic/media content in compressed format, and further configured to decompress the electronic/media content for displaying on the display system 29. The media processor is provided to ensure that content to be displayed is processed accordingly so as to display the information correctly on the display system 29. In one embodiment of the present invention, the display system 29 may be an off-the-shelf LCD or an LED which may be in communication with the control unit to display electronic/media content, in accordance with the various embodiments of the present invention. Accordingly, the display system 29 is not described here in more detail.

The memory 49 is provided to store code or software modules for various applications. In one embodiment of the present invention, the memory 49 may be configured to provide a storage space for electronic/media content that is to be displayed on the display system 29. One of the modules of the memory 49 is to facilitate the operations of many of the components in the control unit 60. Another one of the modules of the memory 49 is to record time, duration or location when a particular piece of electronic/media information has been displayed. Still another one of the modules is a schedule that determines how, when and where a particular piece of electronic/media information needs to be displayed. In one application, the memory 49 is scheduled to download electronic/media information from the base station 41 along with a schedule. In another application, the memory 49 is scheduled to receive certain electronic/media information from the base station 41 when the vehicle 1 is in a coverage area of the base station 41.

The power module 53 may include one or more batteries that may provide power to various components of the control unit 60 as well as the display systems 29. In addition, the power module 53 may include energy storage components, such as rechargeable batteries. The controller/processor 47 may be configured with processor-executable instructions to control the charging of the power module 53 (i.e., the storage of harvested energy), such as by executing a charging control algorithm using a charge control circuit. Alternatively or additionally, the power module 53 may be configured to manage its own charging through a battery used for driving the vehicle 1. Further, alternatively or additionally, the power module 53 may be configured to manage its own charging through a solar panel installed on the vehicle 1.

The controller/processor 47 may be coupled to an output module 55, which may output control signals, which serve as a trigger for the motors 37 that drive the shaft 25 and other components for rotation of the portions/parts of the display rack 9. Based on the reception of such control signals, the motors 37, the belt and pulley drives 39, flat connectors 21, and the shafts 25 trigger the folding and unfolding of the parts/portions of the display rack 9, as described in conjunction with FIGS. 14C and 14D of this disclosure.

The sensor(s) 57 of the control unit 60 may include one or more sensors to determine a current position/orientation of the display rack 9. The current position/orientation of the display rack 9 may be one of a folded position and an unfolded position, as explained throughout the specification. Sensors are well known in the art, and may include, but not limited to, motion or orientation sensors which may assist the control unit 60 in determining the current position/orientation of the display rack 9.

While various components of the control unit 60 are illustrated as separate components, some or all of the components may be integrated together in a single device or module, such as a system-on-chip module.

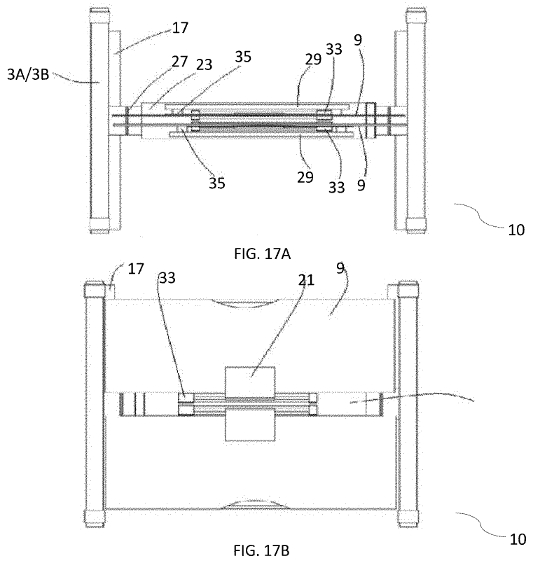

FIGS. 15A and 15B both depict the unfolded views of display rack 9 included in the configurable roof rack, according to various embodiments of the present invention. Each portion or side of the display rack 9 includes a display system 29, such that the two display systems 29 face away from each other. In other words, the two display systems 29 are respectively configured to play electronic content towards each side of the vehicle 1. Various examples of display system may include, but not limited to, a liquid crystal display (LCD) display, a light emitting diode (LED) display, etc. A person skilled in the art would appreciate that any display may be used for display systems 29 which may play electronic content, for example, advertisements, images, etc.

While the isometric view in FIG. 15A depicts the whole unit itself, FIG. 15B depicts the configurable roof rack 10 including the display systems 29 when installed over the roof 5 of the vehicle 1. In the unfolded position, the display systems 29 are fully visible to the public around the vehicle 1 in adjacent lanes, and are ready to have the electronic content turned on and being displayed.

As discussed previously, the display rack 9 is installed on two inner cross bars 17 that are positioned inside the cross bars 3A/3B. The cross bars 3A and 3B are attached to the vehicle 1 using the cross bar clamps 7 affixed on to the roof of the vehicle. The controller box 23 resides on the platform 27 that is connected between each of the two inner crossbars 17. The controller box 23 houses all the electronic, electrical, mechatronic and automation components including wires, circuit boards, Bluetooth, Wi-Fi adapters and sensors. A motor and gear system can also be housed which is connected to the display racks 9 through a gear shaft 25 and flat connector/motor shaft 21/33. This allows the display rack 9 to follow a butterfly wings motion (in this version) to fold and unfold its two portions/sides. The motor and gear are operated remotely from a remote control or a software mobile application using sensors, Wi-Fi and Bluetooth transmitters and receiver circuits housed in the controller box 7. The controller box 23 houses all electronics and wireless related components to help display content on these displays streaming directly from a wireless carrier or from the mobile application on the user's mobile device 31. The power to the whole unit may be drawn from the vehicle battery or rechargeable batteries inside the controller box 23. In case of vehicle battery, wires may be drawn from the battery along the side of the windshield all the way to the controller box. Preferably, this power can be drawn from batteries or solar power or combination of both.

When the user decides not to display any content, he/she can stop the streaming by pressing a button (or a touch input) through user interface of the software mobile application in user's mobile device 31. Additionally, the user interface may provide for a touch input or a button for folding or unfolding of the display rack 9.

FIG. 16 depicts an isometric view of how a hidden or folded display rack 9 will appear on top of a car. Once in this folded position, the flat connector or hinge 21 is visible.

FIG. 17A depicts the unfolded view of the whole unit from the top, in accordance with various embodiments of the present invention. The top view depicts how the two display systems 29 are installed onto the two portions/sides of the display rack 9 using mounts 35. The mounts 35 may be similar to the mounts well-known in the art to hang an LCD or an LED display. Both the portions/sides of the display rack 9 are attached to the motor shaft 33 using flat connectors or hinges 21. FIG. 17B shows the folded view from the top.

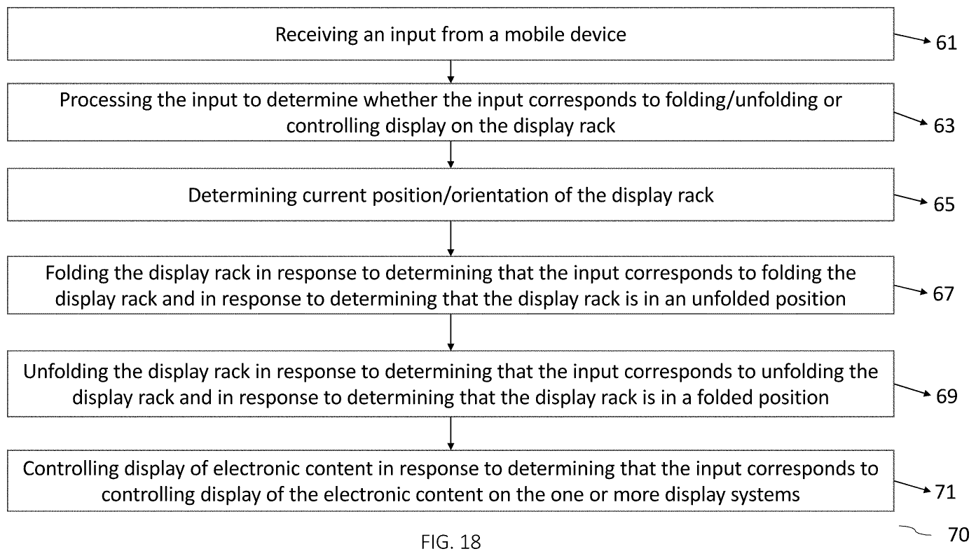

FIG. 18 illustrates a method 70 of operating the configurable roof rack 10 for vehicles, according to various embodiments of the present invention. The method may be performed in a control unit 60, as described in FIG. 14F above.

At step 61, an input may be received, at the control unit 60 of the configurable roof rack 10, from the mobile device 31. More specifically, the input may be received at the controller/processor 47 via the network module 45 of the control unit 60.

At step 63, the input may be processed by the controller/processor 47. Based on the processing, it may be determined whether the input corresponds to folding/unfolding the display rack or corresponds to controlling display of electronic content on one or more display systems of the display rack.

At step 65, a current position/orientation of the display rack may be determined by sensor(s) 57 of the control unit 60. According to various embodiments of the present invention, the current position/orientation may comprise one of a folded position and an unfolded position of the portions/parts of the display rack.

At step 67, the display rack may be folded in response to determining that the input corresponds to folding the display rack, and further in response to determining that the display rack is in an unfolded position. At step 69, the display rack may be unfolded in response to determining that the input corresponds to unfolding the display rack and in response to determining that the display rack is in a folded position. In response to the input, the folding and unfolding of the display rack may be performed by providing a control signal from the output module 55 to the motors 37 and belt and pulley drive 39, as described in conjunction with FIGS. 14C and 14D above.

At step 71, the display of electronic content on the one or more display systems 29 may be controlled, in response to determining that the input corresponds to controlling display of the electronic content on the one or more display systems. According to one exemplary embodiment, controlling the display of electronic content may include switching off or on of the electronic content on the display systems 29. According to another exemplary embodiment, controlling the display of electronic content may include modifying the currently displayed electronic content (e.g. advertisements).

According to an alternative embodiment of the present invention, the input in steps 61 to 71 of the method 70 may correspond to an input received from a server (not shown) instead of the mobile device 31.

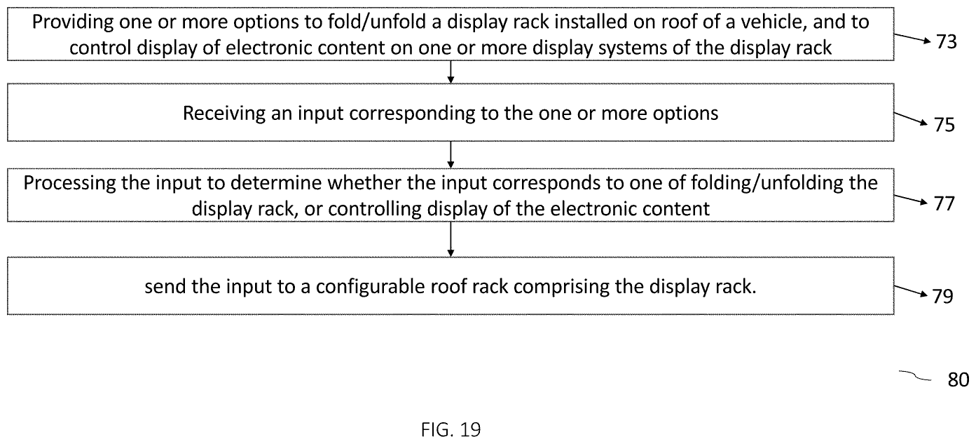

FIG. 19 illustrates a method 80 performed by the mobile device 31 for operating the configurable roof rack 10 for vehicles, according to various embodiments of the present invention. The method may be performed by a processor included within the mobile device 31, by executing processor-executable instructions stored in a memory included within the mobile device 31.

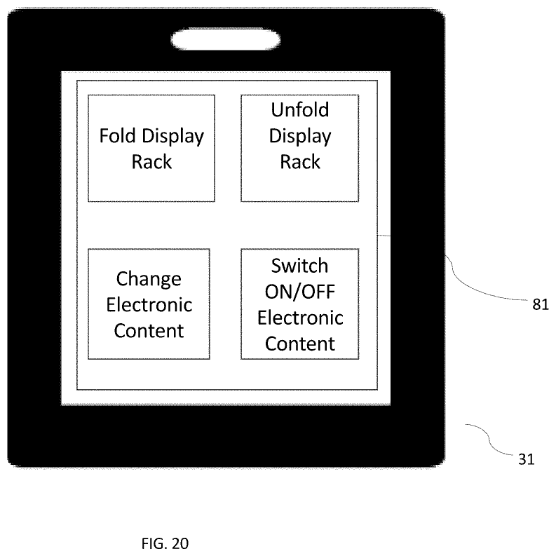

At step 73, one or more options may be provided/displayed via a user interface of the mobile device. The one or more options may include an option to fold/unfold a display rack installed on roof of a vehicle, and an option to control display of electronic content on one or more display systems of the display rack. In an exemplary embodiment, the one or more options may be provided via the user interface (shown in FIG. 20) of a software mobile application installed within the mobile device of the user in the vehicle 1. A user, for example, a driver of the vehicle 1, may provide at least one input corresponding to the one or more options provided via the user interface. For example, the user may select an option of the provided one or more options.

At step 75, an input may be received corresponding to the one or more options. The input may be provided by the user of the vehicle through the user interface of the mobile device. The input may correspond to an instruction to fold the display rack, unfold the display rack, switch on/off the electronic content on the display systems, and/or change electronic content.

At step 77, the input may be processed to determine whether the input corresponds to one of folding/unfolding the display rack, or controlling display of the electronic content on the one or more display systems of the display rack.

At step 79, the input is sent to a configurable roof rack comprising the display rack. The input may be sent as a wireless signal using a wireless communication network/protocol between the mobile device and the control unit 60 of the configurable roof rack 10. The wireless signals and the communication network are well-known in the art and are not described here in detail.

FIG. 20 illustrates a user interface 81 of the mobile device 31, in accordance with various embodiments of the disclosure. According to an embodiment, the user interface 81 may be provided as an interface of a software mobile application installed in the mobile device 31. The user interface 81 may comprise one or more options for folding/unfolding of the display rack installed on roof of the vehicle, and various options to control display of electronic content on one or more display systems of the display rack.

According to an embodiment, the options related to controlling the display of electronic content may comprise an option to switching on/off the electronic content on the display systems, and an option to change electronic content. A user, for example, a driver of the vehicle 1, may provide at least one input corresponding to the one or more options provided via the user interface 81. For example, the user may select an option of the provided one or more options. Upon selection of the option to change electronic content, the user interface 81 may be configured to provide various options of electronic content items (e.g. advertisements, images, video, etc.), and the user may select one or more of these electronic content items for playing on the display systems 29.

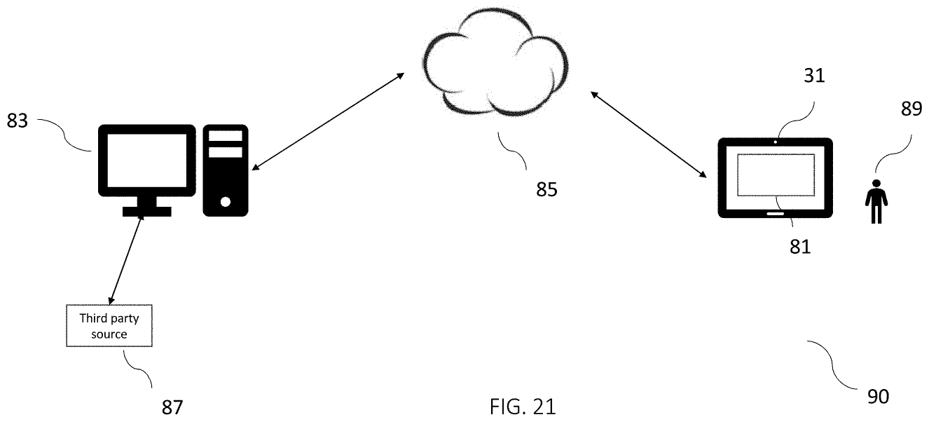

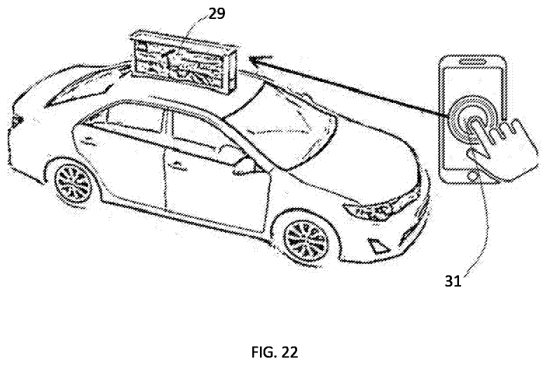

FIG. 21 illustrates a system 90 for providing electronic content for displaying on the one or more display systems 29 of the display rack 9, in accordance with various embodiments of the present invention. The system 90 may include a server 83, a wireless network 85, and the user interface 81 of the mobile device 31.

The server 83 may provide for electronic content to be displayed at one or more display systems 29, controlled via the user interface 81 of the mobile device 31. The server 83 may store the electronic content, such as advertisements, images, etc. to be displayed on the display systems 29. The server, via the wireless network (e.g. internet), may provide such electronic content to the display system via a software mobile application installed in the mobile device 31, as described throughout the specification.

According to an embodiment of the present invention, the server 83 may be configured to receive a current location or a zip code of the vehicle 1. The server may provide the electronic content for displaying on the display systems 29 based on the received current location or zip code of the vehicle. The current location or zip code may be provided through GPS location tracking mechanism of the mobile 31, which would correspond to location or zip code of the vehicle. In other embodiments, the server 83 may provide the electronic content based on the pre-stored preferences of at least one user (e.g. driver or passenger) of vehicle 1. In still other embodiments, the server 83 may track for how long the electronic was played, or a number of times a specific electronic content was played.

In another exemplary embodiment of the present invention, the server 83 may source the electronic content from a third party source 87. The third-party source 87 may include, but not limited to, other servers, websites, storage devices, online library, etc. to provide the electronic content for displaying on the display systems 29. In yet another embodiment, the server 83 may further provide a portal for advertisers (advertising agencies, small businesses, individuals whoever wants to show their ads on top of the car displays). The advertisers may create their own accounts and create their own advertisements using the templates provided on the server 83. The advertising agencies may utilize the APIs provided through the server 83 to load advertisements to the server from the advertising agencies' in-house ad database.

In some embodiments, the electronic content displayed in the two display systems 29 may be different, while in other embodiments, the electronic content in the two display systems 29 may be same. The user interface 81 may provide options accordingly, i.e., options to control the two display systems 29 simultaneously as shown in FIG. 20. While FIG. 20 depicts simultaneous control of two displays for displaying same content on the display systems 29, it may be appreciated by one skilled in the art that the user interface 81 may also provide different options for each of the two display systems 29 for controlling the electronic content to be displayed on the display systems 29, when different content has to be displayed on the display systems 29.

The mobile device 31 of a user 89 may be, for example, but not limited to, a laptop, a mobile phone, a tablet, or any electronic communication device with similar processing capabilities. In various exemplary embodiments of the present invention, the mobile device 31 will provide options to the user for controlling the display and folding/unfolding of the display.

FIG. 22 depicts the user providing an input through a user interface of a software mobile application installed within the mobile device 31, to start or stop content streaming to one or more display systems 29 on top of the vehicle, in accordance with various embodiments of the present invention. The user may use the software mobile application on his/her mobile device (smart phone, tablet, etc.) to control the electronic content including, but not limited to, video, images, advertisements, etc. to be displayed on the display systems 29 located outside the vehicle. By clicking different buttons on the software mobile application, the user may start and stop streaming.

The money businesses and advertisers pay to display their advertisements may be used towards funding the cost of on-demand rideshare trip costs. These advertisements can be displayed on the display systems 29 of the vehicle. For example: a restaurant ABC pays $35/hour to show their advertisements. This amount may be used towards paying partially or fully for all on-demand rideshare trips that is given in an hour.

A preferred embodiment could be an electronic display on top of the rideshare vehicle. An advertiser may pay to show their ads on the display systems 29. The amount may be used to pay for all the rideshare trips and pays the driver as well. In the above example, from the $35/hour, the rideshare driver may get paid $8/hour and all rideshare trips are fully or partially paid by the remaining $27 for an hour. If it provides only partial payment, the riders will pay the remaining which will be highly discounted price than the regular rideshare cost they would otherwise pay.

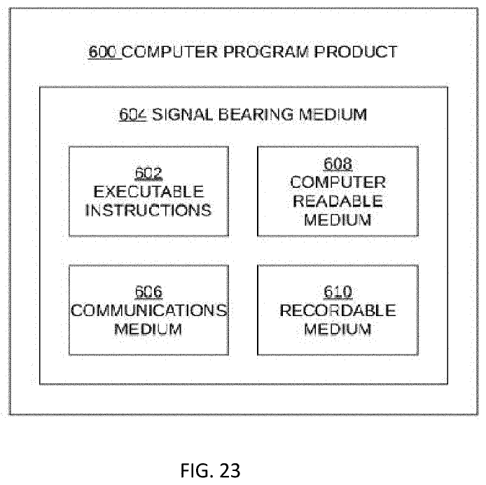

FIG. 23 illustrates an example computer program product that is configured to enable display of electronic content on one or more display systems 29 and/or fold/unfold the display rack 9, arranged in accordance with at least some embodiments described herein. The computer program product 600 may correspond to a program product stored in memory 49 or a program product stored in the form of processor executable instructions stored in mobile device 31.

Computer program product 600 may include a signal bearing medium 604. Signal bearing medium 604 may include one or more instructions 602 that, when executed by, for example, a processor or controller, may provide the functionalities described above to fold/unfold the display rack 9 and/or control display of electronic content on the display systems 29.

In some implementations, signal bearing medium 604 may encompass a computer-readable medium 608, such as, but not limited to, a hard disk drive, a Compact Disc (CD), a Digital Video Disk (DVD), a digital tape, memory, etc. In some implementations, signal bearing medium 604 may encompass a recordable medium 610, such as, but not limited to, memory, read/write (R/W) CDs, R/W DVDs, etc. In some implementations, signal bearing medium 604 may encompass a communications medium 606, such as, but not limited to, a digital and/or an analog communication medium (e.g., a fiber optic cable, a waveguide, a wired communications link, a wireless communication link, etc.). Thus, for example, program product 600 may be conveyed to one or more components of the control unit 60 or mobile device 31 by an RF signal bearing medium 604, where the signal bearing medium 604 is conveyed by a wireless communications medium 606 (e.g., a wireless communications medium conforming with the IEEE 802.11 standard).

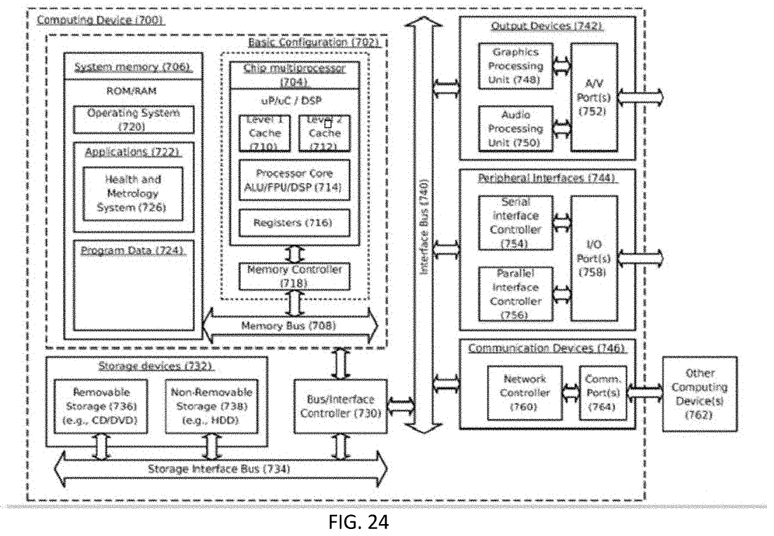

FIG. 24 is a block diagram illustrating an example computing device that is configured to enable display of electronic content on one or more display systems 29 and/or fold/unfold the display rack 9, arranged in accordance with at least some embodiments described herein. In a very basic configuration 702, computing device 700 typically includes one or more processors 704 and a system memory 706. A memory bus 708 may be used for communicating between processor 704 and system memory 706.

Depending on the desired configuration, processor 704 may be of any type including but not limited to a microprocessor (p,P), a microcontroller (piC), a digital signal processor (DSP), or any combination thereof. Processor 704 may include one more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc.) or any combination thereof System memory 706 may include an operating system 720, one or more applications 722, and program data 724. Application 722 may include a document interaction evaluation algorithm 726 that is arranged to perform the functions as described herein including those described with respect to system 100 of FIGS. 1-6. Program data 724 may include document interaction evaluation data 728 that may be useful for implementation of a document interaction evaluator based on an ontology as is described herein. In some embodiments, application 722 may be arranged to operate with program data 724 on operating system 720 such that implementations of evaluating interaction with document based on ontology may be provided. This described basic configuration 702 is illustrated in FIG. 7 by those components within the inner dashed line.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 746) to basic configuration 702 via bus/interface controller 730. Example output devices 742 include a graphics processing unit 748 and an audio processing unit 750, which may be configured to communicate to various external devices such as a display or speakers via one or more AN ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. A configurable roof rack for vehicles, the configurable roof rack comprising:
at least two cross bars arranged parallelly, each of the at least two cross bars comprising a channel; and
a rack comprising an inner cross bar at each of two opposite sides of the rack, wherein the rack is configured to be fitted into the at least two cross bars by sliding the inner cross bars into the channels of the at least two cross bars;
wherein each of the two cross bars comprises a key slot for enabling locking and unlocking of the rack to the at least two cross bars.

2. The configurable roof rack of claim 1, wherein each channel runs through the length of the associated cross bar of the at least two cross bars.

3. The configurable roof rack of claim 1, wherein each key slot comprises a mechanical latch for enabling locking and unlocking of the display rack to the at least two cross bars.

4. The configurable roof rack of claim 1, wherein the channel is arranged on one side of each of the at least two cross bars, and wherein the at least two cross bars are arranged parallelly such that the channel of one cross bar faces the channel of the other cross bar.

5. The configurable roof rack of claim 1, wherein each of the at least two cross bars comprises a stopper at one end and the key slot at another end.

6. The configurable roof rack of claim 1, wherein the display rack is configured to be fitted into the at least two cross bars by sliding the inner cross bars into the channels of the at least two cross bars through the key slots end of the at least two cross bars.

7. The configurable roof rack of claim 1, wherein each of the at least two cross bars are coupled to a roof of a vehicle through at least two cross bar clamps, and wherein the cross bar clamps are fixed into the roof of the vehicle.

8. The configurable roof rack of claim 1, wherein the rack comprises a grip on each of two opposite ends of other two opposite sides of the rack, wherein the other two opposite sides are perpendicular to the two opposite sides including the inner cross bars, and wherein the grips are used to hand grip the rack while fitting in or removing the rack.

9. The configurable roof rack of claim 1, wherein the rack is configured to be removed from the configurable roof rack by pulling the inner cross bars out of the channels of the at least two cross bars.
